(19) United States
(12) Patent Application Publication
(10) Pub. No.: US 2021/0179875 A1
(43) Pub. Date: Jun. 17, 2021

(54) Sublimation-Transfer Ink Jet Ink Composition And Production Method For Printed Article

(71) Applicant: Seiko Epson Corporation, Tokyo (JP)

(72) Inventors: Shigeki KAWADA, Shiojiri (JP); Yasunari IKEDA, Shiojiri (JP)

(21) Appl. No.: 17/122,213

(22) Filed: Dec. 15, 2020

(30) Foreign Application Priority Data
Dec. 16, 2019 (JP) 2019-226272

(51) Int. Cl. C09D 11/328; C09D 11/326; B41M 5/52; B41M 7/00

(52) U.S. Cl. CPC C09D 11/328; C09D 11/326; B41M 2205/02; B41M 7/0027; B41M 5/52

(57) ABSTRACT

A sublimation-transfer ink jet ink composition contains dyes and water, where the dyes include one or more yellow dyes and one or more blue dyes; the yellow dyes include C.I. Solvent Yellow 160:1; and the blue dyes include one or more selected from C.I. Disperse Blue 60, C.I. Disperse Blue 359, and C.I. Disperse Blue 360.

The present application is based on, and claims priority from JP Application Serial Number 2019-226272, filed Dec. 16, 2019, the disclosure of which is hereby incorporated by reference herein in its entirety.

### BACKGROUND

### 1. Technical Field

The present disclosure relates to a sublimation-transfer ink jet ink composition and a production method for a printed article.

### 2. Related Art

An ink jet recording method is employed for dyeing textiles and the like (textile printing). Conventionally, textile screen printing, textile roller printing, and so forth have been employed as printing methods for textiles (woven fabrics and nonwoven fabrics). However, in view of efficiency in high-mix low-volume production, immediate printing properties, and so forth, it is advantageous to employ an ink jet recording method.

One form of textile printing is a transfer-mode textile printing process using sublimation dyes. In this textile printing process, an ink composition is not directly attached to a medium (textile or the like) to be printed. In other words, the ink composition is attached to another medium (paper or the like) as a transfer source and then the dyes are transferred to the medium to be printed from the transfer source medium.

For example, JP-A-2016-190937 discloses an ink set comprising a cyan ink, a magenta ink, and a yellow ink, each of which contains a sublimation dye, where at least either of the magenta ink or the yellow ink contains a dye that exhibits not only sublimation properties but also fluorescent properties. This literature describes excellent coloring properties, especially, coloring properties of composite black.

In recent years, there is a growing need for printing of fluorescent colors by digital textile printing to deal with diverse designs in sportswear and so forth. However, the ink set described in JP-A-2016-190937 exhibits insufficient brightness particularly in textile printing of fluorescent green.

In view of this, it is desirable, in an ink jet ink composition containing a fluorescent colorant, to use a fluorescent colorant having a larger particle size at a higher concentration compared with common pigments and the like. However, when a fluorescent colorant having a large particle size is added at a high concentration to an ink jet ink composition, dispersion stability deteriorates in many cases. Accordingly, it is required to achieve both satisfactory dispersion stability and high fluorescent whitening intensity in an ink jet ink composition containing a fluorescent colorant.

### SUMMARY

An embodiment of the sublimation-transfer ink jet ink composition according to the present disclosure is a sublimation-transfer ink jet ink composition containing dyes and water, where the dyes include one or more yellow dyes and one or more blue dyes; the yellow dyes include C.I. Solvent Yellow 160:1; and the blue dyes include one or more selected from C.I. Disperse Blue 60, C.I. Disperse Blue 359, and C.I. Disperse Blue 360.

In an embodiment of the sublimation-transfer ink jet ink composition, the dyes may solely include the yellow dyes and the blue dyes.

In any of the embodiments of the sublimation-transfer ink jet ink composition, an anionic dispersant may be contained further.

In the above embodiment of the sublimation-transfer ink jet ink composition, the anionic dispersant may be naphthalenesulfonic acid-formaldehyde condensate sodium salt.

In any of the embodiments of the sublimation-transfer ink jet ink composition, a content of C.I. Solvent Yellow 160:1 may be 0.5% by mass or more and 14.0% by mass or less based on a total amount of the sublimation-transfer ink jet ink composition.

In any of the embodiments of the sublimation-transfer ink jet ink composition, a ratio of a content of C.I. Solvent Yellow 160:1 to a total content of the blue dyes may be 0.5 or more and 2.0 or less.

An embodiment of the production method for a printed article according to the present disclosure includes: attaching the sublimation-transfer ink jet ink composition of any of the above-mentioned embodiments to a recording surface of transfer paper by an ink jet method; and thermally transferring by disposing the recording surface and a recording medium to face each other, followed by heating.

### DESCRIPTION OF EXEMPLARY EMBODIMENTS

Hereinafter, embodiments of the present disclosure will be described. The following embodiments will be described as examples of the present disclosure.

Accordingly, the present disclosure is by no means limited to the following embodiments and encompasses various modifications carried out without changing the gist of the present disclosure. It is noted that all the constitution described hereinafter is not necessarily the essential constitution of the present disclosure.

### 1. Sublimation-Transfer Ink Jet Ink Composition

A sublimation-transfer ink jet ink composition of the present embodiment contains dyes and water. The dyes include one or more yellow dyes and one or more blue dyes.

### 1. 1. Dyes

The sublimation-transfer ink jet ink composition according to the present embodiment contains, as the dyes, one or more yellow dyes and one or more blue dyes.

The dyes contained in the sublimation-transfer ink jet ink composition are a type of sublimation dyes suitably used for dyeing hydrophobic synthetic fibers, such as polyesters, nylons, and acetates. Sublimation dyes are water-insoluble or scarcely-soluble compounds having properties of subliming upon heating. Herein, dyes exhibiting sublimation properties are referred to as sublimation dyes regardless of the classifications, such as disperse dyes and oil-soluble dyes.

By including C.I. Solvent Yellow 160:1 as a yellow dye and one or more selected from C.I. Disperse Blue 60, C.I. Disperse Blue 359, and C.I. Disperse Blue 360 as blue dyes described hereinafter, the sublimation-transfer ink jet ink composition according to the present embodiment can dye textiles and the like with green tone of satisfactory fluorescent whitening intensity while exhibiting satisfactory dispersion stability.

### 1. 1. 1. Yellow Dyes

The sublimation-transfer ink jet ink composition of the present embodiment contains one or more yellow dyes, and the yellow dyes include at least C.I. Solvent Yellow 160:1.

The content of C.I. Solvent Yellow 160:1 is 0.2% by mass or more and 15.0% by mass or less, preferably 0.5% by mass or more and less than 15.0% by mass, more preferably 0.5% by mass or more and 14.0% by mass or less, and further preferably 5.0% by mass or more and 12.0% by mass or less based on the total amount of the sublimation-transfer ink jet ink composition. When the content of C.I. Solvent Yellow 160:1 falls within these ranges, textiles and the like are readily dyed with green of satisfactory fluorescent whitening intensity. Moreover, since C.I. Solvent Yellow 160:1 exhibits relatively satisfactory dispersion stability, it is also possible to ensure the stability of the sublimation-transfer ink jet ink composition.

### 1. 1. 2. Blue Dyes

The sublimation-transfer ink jet ink composition of the present embodiment contains one or more blue dyes, and the blue dyes include one or more selected from C.I. Disperse Blue 60, C.I. Disperse Blue 359, and C.I. Disperse Blue 360.

The total content of C.I. Disperse Blue 60, C.I. Disperse Blue 359, and C.I. Disperse Blue 360 is 0.2% by mass or more and 15.0% by mass or less, preferably 0.5% by mass or more and less than 15.0% by mass, more preferably 0.5% by mass or more and 14.0% by mass or less, and further preferably 5.0% by mass or more and 12.0% by mass or less based on the total amount of the sublimation-transfer ink jet ink composition. When the content of C.I. Disperse Blue 60, C.I. Disperse Blue 359, and C.I. Disperse Blue 360 falls within these ranges, textiles and the like are readily dyed with green of satisfactory fluorescent whitening intensity. Moreover, since these dyes exhibit relatively satisfactory dispersion stability, it is also possible to ensure the stability of the sublimation-transfer ink jet ink composition.

Meanwhile, a proper range exists for a ratio between the total content of C.I. Disperse Blue 60, C.I. Disperse Blue 359, and C.I. Disperse Blue 360 relative to the total amount of the sublimation-transfer ink jet ink composition and the content of C.I. Solvent Yellow 160:1 relative to the total amount of the sublimation-transfer ink jet ink composition. Specifically, a ratio of the content of C.I. Solvent Yellow 160:1 to the total content of the blue dyes is 0.3 or more and 3.0 or less, preferably 0.5 or more and 2.0 or less, and more preferably 0.75 or more and 1.25 or less. When the content ratio falls within these ranges, textiles and the like are readily dyed with green of further satisfactory fluorescent whitening intensity.

Although the details of the mechanism are unknown, a sublimation-transfer ink jet ink composition exhibits particularly satisfactory dispersion stability when C.I. Solvent Yellow 160:1 and C.I. Disperse Blue 359 are contained.

### 1. 1. 3. Other Dyes

The sublimation-transfer ink jet ink composition of the present embodiment may solely contain, as the dyes, C.I. Solvent Yellow 160:1 and one or more selected from C.I. Disperse Blue 60, C.I. Disperse Blue 359, and C.I. Disperse Blue 360 but may contain other dyes, for example, for the purpose of adjusting the hue obtained in textiles and the like.

Exemplary other dyes include, but are not particularly limited to, yellow dyes excluding C.I. Solvent Yellow 160:1; blue dyes excluding C.I. Disperse Blue 60, C.I. Disperse Blue 359, and C.I. Disperse Blue 360; orange dyes; red dyes; violet dyes; green dyes; brown dyes; and black dyes. These dyes are preferably sublimation dyes.

Exemplary yellow sublimation dyes other than the above-described C.I. Solvent Yellow 160:1 include C.I. Disperse Yellow 1, 3, 4, 5, 7, 8, 9, 13, 16, 23, 24, 30, 31, 33, 34, 39, 41, 42, 44, 49, 50, 51, 54, 56, 58, 60, 61, 63, 64, 66, 68, 71, 74, 76, 77, 78, 79, 83, 85, 86, 88, 90, 91, 93, 98, 99, 100, 104, 108, 114, 116, 118, 119, 122, 124, 126, 135, 140, 141, 149, 153, 160, 162, 163, 164, 165, 179, 180, 182, 183, 184, 186, 192, 198, 199, 201, 202, 204, 210, 211, 215, 216, 218, 224, 227, 231, 232, 233, and 245; and C.I. Solvent Yellow 2, 6, 14, 16, 21, 25, 29, 30, 33, 51, 56, 77, 80, 82, 88, 89, 93, 116, 150, 163, and 179.

Exemplary blue sublimation dyes other than the above-described C.I. Disperse Blue 60, C.I. Disperse Blue 359, and C.I. Disperse Blue 360 include C.I. Disperse Blue 3, 5, 6, 7, 9, 14, 16, 19, 20, 24, 26, 26:1, 27, 35, 43, 44, 52, 54, 55, 56, 58, 61, 62, 64, 64:1, 71, 72, 72:1, 73, 75, 77, 77:1, 79, 81, 81:1, 82, 83, 85, 87, 88, 90, 91, 93, 94, 95, 96, 99, 102, 106, 108, 112, 113, 115, 118, 120, 122, 125, 128, 130, 131, 139, 141, 142, 143, 145, 146, 148, 149, 153, 154, 158, 165, 167, 171, 173, 174, 176, 181, 183, 185, 186, 187, 189, 197, 198, 200, 201, 205, 207, 211, 214, 224, 225, 241, 257, 259, 267, 268, 270, 284, 285, 287, 288, 291, 293, 295, 297, 301, 315, 330, 333, 354, and 367; and C.I. Solvent Blue 2, 11, 14, 24, 25, 35, 36, 38, 48, 55, 59, 63, 67, 68, 70, 73, 83, 105, 111, and 132.

Exemplary orange sublimation dyes include C.I. Disperse Orange 1, 1:1, 3, 5, 7, 11, 13, 17, 20, 21, 25, 25:1, 29, 30, 31, 32, 33, 37, 38, 41, 42, 43, 44, 45, 46, 47, 48, 49, 50, 51, 53, 54, 55, 56, 57, 58, 59, 61, 66, 71, 73, 76, 78, 80, 89, 90, 91, 93, 96, 97, 119, 127, 130, 139, and 142; and C.I. Solvent Orange 1, 2, 14, 45, and 60.

Exemplary red sublimation dyes include C.I. Disperse Red 1, 4, 5, 6, 7, 11, 12, 13, 15, 17, 27, 43, 44, 50, 52, 53, 54, 55, 55;1, 56, 58, 59, 60, 65, 70, 72, 73, 74, 75, 76, 78, 81, 82, 83, 84, 86, 86:1, 88, 90, 91, 92, 93, 96, 97, 99, 100, 101, 103, 104, 105, 106, 107, 108, 110, 111, 113, 116, 117, 118, 121, 122, 125, 126, 127, 128, 129, 131, 132, 134, 135, 137, 143, 145, 146, 151, 152, 153, 154, 157, 158, 159, 164, 167, 167:1, 169, 177, 179, 181, 183, 184, 185, 188, 189, 190, 190:1, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, and 328; C.I. Solvent Red 1, 3, 7, 8, 9, 18, 19, 23, 24, 25, 27, 49, 100, 109, 121, 122, 125, 127, 130, 132, 135, 218, 225, and 230.

Exemplary violet sublimation dyes include C.I. Disperse Violet 1, 4, 8, 10, 17, 18, 23, 24, 26, 27, 28, 29, 30, 31, 33, 35, 36, 37, 38, 40, 43, 46, 48, 50, 51, 52, 56, 57, 59, 61, 63, 69, and 77; and C.I. Solvent Violet 13.

Exemplary green sublimation dyes include C.I. Disperse Green 9 and C.I. Solvent Green 3.

Exemplary brown sublimation dyes include C.I. Disperse Brown 1, 2, 4, 9, 13, and 19; and C.I. Solvent Brown 3 and 5.

Exemplary black sublimation dyes include C.I. Disperse Black 1, 2, 3, 10, 24, 26, 27, 28, 30, and 31; and C.I. Solvent Black 3, 5, 7, 23, 27, 28, 29, and 34.

The above-mentioned exemplary sublimation dyes may be used alone or in combination of two or more.

Herein, “sublimation dyes” are dyes having properties of subliming upon heating. Such dyes are suitable for dyeing textiles and the like, in other words, textile printing that utilizes sublimation transfer. Exemplary textile printing methods utilizing sublimation transfer include a method of printing on a sheet-like intermediate transfer medium as a transfer source, such as paper, by an ink jet method using an ink containing sublimation dyes; then disposing the intermediate transfer medium on a recording medium, such as a textile; and heating for sublimation transfer. Other methods include a method of printing on a releasable ink receiving layer provided on a recording medium, such as a film product, by an ink jet method using a sublimation-transfer ink; then heating the recording medium as it is for sublimation/diffusion dyeing of the lower layer side of the recording medium; and subsequently releasing the ink receiving layer.

All of the above-mentioned exemplary sublimation dyes are water-insoluble or scarcely-soluble compounds. However, within a specific concentration range, it is possible to satisfactorily disperse these dyes in water, for example, by using a dispersant described hereinafter. Here, such dispersing is also referred to as emulsifying in the case of oil-soluble dyes. Further, the above-mentioned exemplary sublimation dyes are slightly different in dispersibility. In other words, a suitable concentration range of a dispersant varies depending on the types of sublimation dyes, and dispersibility also varies depending on the types of dispersants in some cases.

The total content of dyes in a sublimation-transfer ink jet ink composition is preferably 0.4% by mass or more and 30.0% by mass or less, more preferably 1.0% by mass or more and 25.0% by mass or less, further preferably 10.0% by mass or more and 23.0% by mass or less, and still further preferably 15.0% by mass or more and 20.0% by mass or less based on 100% by mass of the sublimation-transfer ink jet ink composition. When the content of dyes in a sublimation-transfer ink jet ink composition falls within these ranges, it is possible to achieve satisfactory coloring properties, in other words, satisfactory OD values of transferred articles to be obtained.

### 1. 2. Water

In the present embodiment, a sublimation-transfer ink jet ink composition contains water. Examples of water include pure water, such as deionized water, ultrafiltration water, reverse osmosis water, and distilled water; and water from which ionic impurities have been removed as much as possible, such as ultrapure water. Moreover, by using water that has been sterilized, for example, by UV irradiation or addition of hydrogen peroxide, it is possible to suppress the growth of bacteria and/or fungi during long-term storage of the ink composition.

The content of water is preferably 40% by mass or more and 90% by mass or less and more preferably 50% by mass or more and 85% by mass or less based on the total mass of a sublimation-transfer ink jet ink composition.

### 1. 3. Other Components

The sublimation-transfer ink jet ink composition of the present embodiment may contain the following components.

### 1. 3. 1. Dispersants

The sublimation-transfer ink jet ink composition of the present embodiment may contain a dispersant. Such a dispersant acts to disperse the above-described dyes in a sublimation-transfer ink jet ink composition in a stable manner. Exemplary dispersants include, but are not particularly limited to, anionic dispersants, nonionic dispersants, and polymer dispersants. Among the following exemplary dispersants, anionic dispersants are more preferably used in view of further excellent dispersion stability of a sublimation-transfer ink jet ink composition.

Exemplary anionic dispersants preferably include aromatic sulfonic acid-formaldehyde condensates. Exemplary “aromatic sulfonic acids” of the aromatic sulfonic acid-formaldehyde condensates include creosote oil sulfonic acid; cresol sulfonic acid; phenol sulfonic acid; β-naphthol sulfonic acid; alkylnaphthalenesulfonic acids, such as methylnaphthalenesulfonic acid and butylnaphthalenesulfonic acid; a mixture of β-naphthalenesulfonic acid and β-naphthol sulfonic acid; a mixture of cresol sulfonic acid and 2-naphthol-6-sulfonic acid; and ligninsulfonic acid.

As anionic dispersants, β-naphthalenesulfonic acid-formaldehyde condensate, alkylnaphthalenesulfonic acid-formaldehyde condensates, and creosote oil sulfonic acid-formaldehyde condensate are preferable. Among these anionic dispersants, β-naphthalenesulfonic acid-formaldehyde condensate is particularly preferable.

Exemplary nonionic dispersants include phytosterol-ethylene oxide adducts and cholestanol-ethylene oxide adduct.

Exemplary polymer dispersants include partial alkyl esters of polyacrylic acid, polyalkylenepolyamines, polyacrylic acid salts, styrene-acrylic acid copolymer, and vinylnaphthalene-maleic acid copolymer.

These dispersants may be used alone or in combination of two or more. The total content of dispersants is 0.1% by mass or more and 30.0% by mass or less, preferably 0.4% by mass or more and 30.0% by mass or less, more preferably 1.0% by mass or more and 25.0% by mass or less, further preferably 10.0% by mass or more and 23.0% by mass or less, and particularly preferably 15.0% by mass or more and 20.0% by mass or less based on 100% by mass of a sublimation-transfer ink jet ink composition. When the dispersant content is 0.1% by mass or more, it is possible to ensure the dispersion stability of dyes. Meanwhile, when the dispersant content is 30.0% by mass or less, it is possible to prevent excessive dissolution of dyes and to maintain low viscosity.

### 1. 3. 2. Other Components

### Water-Soluble Organic Solvents

A sublimation-transfer ink jet ink composition may contain a water-soluble organic solvent. By incorporating a water-soluble organic solvent into a sublimation-transfer ink jet ink composition, it is possible to achieve excellent discharge stability by an ink jet method of the sublimation-transfer ink jet ink composition and to effectively suppress moisture evaporation from a recording head during long-term storage. Moreover, a water-soluble organic solvent may function as a humectant.

Exemplary water-soluble organic solvents include polyol compounds and glycol ethers.

Exemplary polyol compounds include polyol compounds and preferably diol compounds that have 2 or more and 6 or less carbon atoms within the molecule and that may have one ether linkage within the molecule. Specific examples include glycols, such as 1,2-pentanediol, glycerol, ethylene glycol, diethylene glycol, triethylene glycol, polyethylene glycol, propylene glycol, dipropylene glycol, tripropylene glycol, polypropylene glycol, polyoxyethylene-polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-(hexyloxy)-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, and 3-methyl-1,5-pentanediol.

Exemplary glycol ethers include monoalkyl ethers of glycols that are selected from ethylene glycol, diethylene glycol, triethylene glycol, polyethylene glycol, propylene glycol, dipropylene glycol, tripropylene glycol, polypropylene glycol, and polyoxyethylene-polyoxypropylene glycol, for example. Exemplary monoalkyl ethers include triethylene glycol monomethyl ether, triethylene glycol monobutyl ether, and dipropylene glycol monopropyl ether.

A plurality of water-soluble organic solvents may be mixed and used. From a viewpoint of adjusting the viscosity of a sublimation-transfer ink jet ink composition and preventing clogging through moistening effects, the content of a water-soluble organic solvent is preferably 0.2% by mass or more and 30% by mass or less and more preferably 1% by mass or more and 25% by mass or less based on the total mass of the sublimation-transfer ink jet ink composition.

### Surface Tension Modifiers

A sublimation-transfer ink jet ink composition may contain a surface tension modifier. The surface tension modifier is used for lowering surface tension during dissolution in water and adjusting the wettability of an ink toward printing substrates or discharge channels. Such a surface tension modifier is selected from surfactant-based surface tension modifiers and water-soluble solvent-based surface tension modifiers that exhibit low surface tension properties.

Exemplary water-soluble solvent-based surface tension modifiers include lower alcohols, such as ethanol, propanol, and butanol; diols, such as butylene glycol, 1,3-pentanediol, 2-ethyl-1,3-propanediol, and 1,6-hexanediol; and glycol monoethers, such as ethylene glycol monomethyl ether, ethylene glycol monoethyl ether, diethylene glycol monomethyl ether, diethylene glycol monoethyl ether, and propylene glycol monomethyl ether.

The surfactant-based surface tension modifiers may be appropriately selected from nonionic surfactants, anionic surfactants, cationic surfactants, and amphoteric surfactants, for example. Among these surfactants, silicone surfactants and acetylenic glycol surfactants that have high surface activity and low foaming properties are more preferable.

Exemplary commercial acetylenic glycol surfactants include, but are not particularly limited to, Olfine E 1004, E 1010, E 1020, PD-001, PD-002W, PD-004, PD-005, EXP. 4200, EXP. 4123, EXP. 4300, Surfynol 440, 465, 485, CT 111, CT 121, TG, GA, Dynol 604, and 607 from Nissin Chemical Industry Co. Ltd.; and Acetylenol E40, E60, and E100 from Kawaken Fine Chemicals Co., Ltd.

Exemplary silicone surfactants include polysiloxane compounds and polyether-modified organosiloxanes. Exemplary commercial silicone surfactants include, but are not particularly limited to, BYK-306, BYK-307, BYK-333, BYK-341, BYK-345, BYK-346, BYK-347, BYK-348, and BYK-349 from BYK Japan KK; KF-351A, KF-352A, KF-353, KF-354L, KF-355A, KF-615A, KF-945, KF-640, KF-642, KF-643, KF-6020, X-22-4515, KF-6011, and KF-6012 from Shin-Etsu Chemical Co., Ltd.; and Silface SAG 002, 005, 503A, and 008 from Nissin Chemical Industry Co. Ltd.

The content of a surface tension modifier is preferably 0.01% by mass or more and 2.0% by mass or less and more preferably 0.1% by mass or more and 1.5% by mass or less based on the total mass of a sublimation-transfer ink jet ink composition.

### pH Adjusters

A sublimation-transfer ink jet ink composition may contain a pH adjuster. Examples of the pH adjuster include, but are not particularly limited to, appropriate combinations of an acid, a base, a weak acid, and/or a weak base. Exemplary acids and bases used for such combinations include inorganic acids, such as sulfuric acid, hydrochloric acid, and nitric acid; inorganic bases, such as lithium hydroxide, sodium hydroxide, potassium hydroxide, monopotassium phosphate, disodium phosphate, potassium carbonate, sodium carbonate, sodium bicarbonate, and ammonia; organic bases, such as triethanolamine, diethanolamine, monoethanolamine, tripropanolamine, triisopropanolamine, diisopropanolamine, and tris(hydroxymethyl)aminomethane (THAM); organic acids, such as adipic acid, citric acid, succinic acid, lactic acid, Good's buffers, such as N,N-bis(2-hydroxyethyl)-2-aminoethanesulfonic acid (BES), 2-[4-(2-hydroxyethyl)-1-piperazinyl]ethanesulfonic acid (HEPES), 2-morpholinoethanesulfonic acid (MES), N-(carbamoylmethyl)iminodiacetic acid (ADA), piperazine-1,4-bis(2-ethanesulfonic acid) (PIPES), N-(2-acetamido)-2-aminoethanesulfonic acid (ACES), cholamine chloride hydrochloride, N-tris(hydroxymethyl)methyl-2-aminoethanesulfonic acid (TES), acetamidoglycine, tricine, glycinamide, and bicine, phosphate buffers, citrate buffers, and Tris buffers. Among these pH adjusters, it is preferable to contain, as a part or the whole of pH adjuster, a tertiary amine, such as triethanolamine or triisopropanolamine, and a carboxy group-containing organic acid, such as adipic acid, citric acid, succinic acid, or lactic acid since pH buffering effects can be obtained in a further stable manner.

### Humectants

A sublimation-transfer ink jet ink composition may contain a humectant. Any humectant commonly used for an ink jet ink composition can be used without any particular limitation.

Specific examples of humectants that also function as water-soluble organic solvents include polyols, such as diethylene glycol, triethylene glycol, tetraethylene glycol, pentamethylene glycol, trimethylene glycol, 2-butene-1,4-diol, 2-ethyl-1,3-hexanediol, 2-methyl-2,4-pentanediol, tripropylene glycol, isobutylene glycol, glycerol, diglycerol, meso-erythritol, trimethylolpropane, pentaerythritol, and dipentaerythritol. Further, specific examples of other humectants include lactams, such as 2-pyrrolidone, N-methyl-2-pyrrolidone, ε-caprolactam, and hydroxyethylpyrrolidone; urea; urea derivatives, such as thiourea, ethyleneurea, and 1,3-dimethylimidazolidinone; monosaccharides, disaccharides, oligosaccharides, polysaccharides, and derivatives of these saccharides, such as glucose, mannose, fructose, ribose, xylose, arabinose, galactose, aldonic acids, glucitol (sorbit), maltose, cellobiose, lactose, sucrose, trehalose, and maltotriose; and betaines, such as trimethylglycine.

Saccharides herein refer to monosaccharides, disaccharides, oligosaccharides including trisaccharides and tetrasaccharides, and polysaccharides. Exemplary saccharides include threose, erythrulose, erythrose, arabinose, ribulose, ribose, xylose, xylulose, lyxose, glucose, fructose, mannose, idose, sorbose, gulose, talose, tagatose, galactose, allose, psicose, altrose, maltose, isomaltose, cellobiose, lactose, sucrose, trehalose, isotrehalose, gentiobiose, melibiose, turanose, sophorose, isosaccharose, homoglycans, such as glucan, fructan, mannan, xylan, galacturonan, mannuronan, and N-acetylglucosamine polymer, heteroglycans, such as diheteroglycans and triheteroglycans, maltotriose, isomaltotriose, panose, maltotetraose, and maltopentaose.

When a sublimation-transfer ink jet ink composition contains a humectant in the present embodiment, the content is preferably 0.2% by mass or more and 30.0% by mass or less and more preferably 1.0% by mass or more and 25% by mass or less based on the total mass of the sublimation-transfer ink jet ink composition.

### Chelating Agents

A sublimation-transfer ink jet ink composition may contain a chelating agent. Exemplary chelating agents include ethylenediaminetetraacetic acid and salts thereof. Exemplary salts include ethylenediaminetetraacetic acid disodium salt, and ethylenediamine nitrilotriacetate salts, hexametaphosphate salts, pyrophosphate salts, and metaphosphate salts.

### Preservatives, Fungicides

A sublimation-transfer ink jet ink composition may contain a preservative or a fungicide as necessary. Exemplary preservatives and fungicides include sodium benzoate, pentachlorophenol sodium salt, 2-pyridinethiol 1-oxide sodium salt, sodium sorbate, sodium dehydroacetate, 1,2-benzisothiazolin-3-one, and 4-chloro-3-methylphenol.

### Others

As components other than the above-described ones, a sublimation-transfer ink jet ink composition may contain, as necessary, additives commonly and optionally used in ink jet ink compositions, such as anticorrosive agents, antioxidants, UV absorbers, oxygen absorbers, and dissolution aids.

### 1. 4. Physical Properties and Production of Sublimation-Transfer Ink Jet Ink Composition

A sublimation-transfer ink jet ink composition has a surface tension at 25.0° C. of preferably 10.0 mN/m or more and 40.0 mN/m or less and more preferably 25.0 mN/m or more and 40.0 mN/m or less. The surface tension can be measured using an automatic surface tensiometer CBVP-Z from Kyowa Interface Science Co., Ltd. as a surface tension when a platinum plate is wetted with a composition in an environment of 25.0° C.

A sublimation-transfer ink jet ink composition has a viscosity at 20.0° C. of preferably 1.5 mPa·s or more and 10.0 mPa·s or less and more preferably 2.0 mPa·s or more and 8.0 mPa·s or less. To control the surface tension and viscosity within the above-mentioned ranges, for example, the types of the foregoing water-soluble organic solvents and surfactants as well as the amounts of the solvents, surfactants, and water added may be adjusted appropriately. Here, the viscosity can be measured using a viscoelasticity tester MCR-300 from Anton Paar Japan K.K. by increasing a shear rate from 10 to 1,000 in an environment of 20.0° C. and reading the viscosity at a shear rate of 200.

A sublimation-transfer ink jet ink composition has a pH of preferably 5.8 or more and 10.5 or less and more preferably 6.0 or more and 10.0 or less. When the pH of the sublimation-transfer ink jet ink composition falls within these ranges, it is possible, for example, to suppress corrosion of a recording head or components of an ink jet recording apparatus.

A sublimation-transfer ink jet ink composition is obtained by mixing the above-described respective components in an appropriate order and, as necessary, by removing impurities through filtration or the like. As the mixing method for the respective components, a method of successively adding materials to a vessel equipped with a stirring device, such as a mechanical stirrer or a magnetic stirrer, and mixing with stirring is suitably employed. Here, a dye may be added in the form of a dispersion in which the dye has been dispersed in advance using a dispersant.

### 1. 5. Action and Effects

The sublimation-transfer ink jet ink composition according to the present embodiment is suitably applicable to a dyeing method for textiles and the like utilizing sublimation transfer. Specifically, by using the sublimation-transfer ink jet ink composition according to the present embodiment for the production method for a printed article described hereinafter, C.I. Solvent Yellow 160:1 and one or more selected from C.I. Disperse Blue 60, C.I. Disperse Blue 359, and C.I. Disperse Blue 360 are attached to transfer paper by an ink jet method to form a transfer image, and the resulting transfer image is transferred to a textile. As a result, a transferred article of green tone having satisfactory fluorescent whitening intensity can be obtained. Moreover, since the sublimation-transfer ink jet ink composition according to the present embodiment contains C.I. Solvent Yellow 160:1 and one or more selected from C.I. Disperse Blue 60, C.I. Disperse Blue 359, and C.I. Disperse Blue 360, dispersion stability is satisfactory.

### 2. Production Method for Printed Article

The production method for a printed article according to the present embodiment includes: attaching the above-described sublimation-transfer ink jet ink composition to a recording surface of transfer paper by an ink jet method; and thermally transferring by disposing the recording surface and a recording medium to face each other, followed by heating.

Here, exemplary production methods for a printed article utilizing sublimation transfer include a method of printing on a sheet-like intermediate transfer medium, such as transfer paper, by an ink jet method using a sublimation-transfer ink jet ink composition containing sublimation dyes to form a transfer image; and sublimation-transferring the resulting transfer image by disposing the intermediate transfer medium on a recording medium (transfer target medium), such as a textile, followed by heating.

In other words, the production method for a printed article according to the present embodiment includes at least an ink attaching step of attaching the above-described sublimation-transfer ink jet ink composition to transfer paper by discharging from a recording head; and a transfer step of transferring dyes contained in the sublimation-transfer ink jet ink composition from the transfer paper to a recording medium through sublimation transfer.

### 2. 1. Ink Attaching Step

In this step, by employing an ink jet method, the above-described sublimation-transfer ink jet ink composition is discharged from a recording head and attached to the recording surface of transfer paper, which is an intermediate transfer medium, to form a transfer image. The discharge of a sublimation-transfer ink jet ink composition by an ink jet method may be performed using, for example, a droplet discharge apparatus, such as an ink jet recording apparatus.

A usable ink jet recording apparatus is not particularly limited provided that the apparatus includes at least an ink storage container, such as a cartridge or a tank, for storing the above-described sublimation-transfer ink jet ink composition and a recording head connected therewith and the apparatus can discharge the sublimation-transfer ink jet ink composition from the recording head to form an image on transfer paper as an intermediate transfer medium. Moreover, both serial-type and line-type ink jet recording apparatuses can be used. These types of ink jet recording apparatuses equipped with a recording head intermittently discharge droplets of an ink composition at a predetermined timing and a predetermined volume from nozzle openings of the recording head while changing relative positional relationships between transfer paper and the recording head. Through this procedure, a sublimation-transfer ink jet ink composition can be attached to the transfer paper, thereby forming a predetermined transfer image.

In a serial-type ink jet recording apparatus, in which the transport direction of transfer paper crosses the direction of reciprocating motion of the recording head, the relative positional relationship between the transfer paper and the recording head is generally changed by combinations of the reciprocating motion of the recording head and the transport motion of the transfer paper. In this case, a plurality of nozzle openings are typically disposed in the recording head to form a row of nozzle openings or a nozzle row in the transport direction of the transfer paper. Further, a plurality of nozzle rows are formed in the recording head in some cases depending on the types or the number of sublimation-transfer ink jet ink compositions.

In a line-type ink jet recording apparatus, in general, the recording head does not make reciprocating motion and the relative positional relationship between transfer paper and the recording head is changed by the transport of the transfer paper. In this case as well, a plurality of nozzle openings are typically disposed in the recording head, and nozzle rows are formed in the direction crossing the transport direction of the transfer paper.

An ink jet recording method is not particularly limited provided that a sublimation-transfer ink jet ink composition can be discharged as droplets from fine nozzle openings, thereby attaching the resulting droplets to transfer paper. As an ink jet recording method, for example, a piezo method or a method of discharging inks by bubbles generated upon heating of the inks may be employed. In the present embodiment, a piezo method is preferably employed in view of, for example, suppressed deterioration of ink compositions.

An ink jet recording apparatus used in the present embodiment may employ, without limitation, publicly known components, such as a heating unit, a drying unit, a roll unit, and a take-up device.

In the present embodiment, paper, such as standard paper; ink jet paper; recording media provided with an ink receiving layer, such as coated paper; and so forth may be used for transfer paper as an intermediate transfer medium. However, paper provided with an ink receiving layer of inorganic fine particles, such as silica, is preferable. By using such paper, it is possible, in the drying process of a sublimation-transfer ink jet ink composition applied to an intermediate transfer medium, to obtain an intermediate recorded article in which bleeding or the like on the recording surface is suppressed. Moreover, such a medium readily holds sublimation dyes on the recording surface and enables further efficient sublimation of the dyes in the later transfer step.

### 2. 2. Transfer Step

The production method for a printed article according to the present embodiment includes a transfer step of transferring sublimation dyes contained in a sublimation-transfer ink jet ink composition to a textile or the like to be printed through sublimation by heating the recording surface of transfer paper to which the sublimation-transfer ink jet ink composition has been applied and which has been disposed to face a recording medium, such as a polyester textile to be printed, in other words, by heating the recording surface of transfer paper on which a textile or the like has been disposed. Through this step, a printed textile or the like, in other words, a printed article is obtained.

The heating temperature in the transfer step is not particularly specified but is preferably 160.0° C. or higher and 220.0° C. or lower and more preferably 170.0° C. or higher and 200.0° C. or lower. Such a heating temperature can provide sufficient energy for transferring sublimation dyes to a textile to be printed, thereby achieving excellent productivity of printed articles.

The heating time in the transfer step is preferably 30.0 seconds or more and 90.0 seconds or less and more preferably 45.0 seconds or more and 60.0 seconds or less, although depending on the heating temperature. Such a heating time can provide sufficient energy for transferring sublimation dyes to a textile to be printed, thereby achieving particularly excellent productivity of printed articles.

Here, the transfer step may be performed by heating transfer paper to which a sublimation-transfer ink jet ink composition has been applied and which has been disposed to face a textile to be printed. However, it is preferable to perform the transfer step by heating transfer paper in contact with a textile to be printed. Consequently, it is possible to obtain, for example, a printed article in which a further vivid image has been recorded on a textile or the like.

Exemplary recording media, in other words, textiles to be printed include polyester textiles, which are hydrophobic fiber textiles. In addition, sheet-like articles, such as resin films, and articles having a three-dimensional shape other than a sheet shape, such as a spherical shape, a rectangular parallelepiped shape, or curved surfaces, may also be used.

### 2. 3. Other Steps

The production method for a printed article according to the present embodiment may include, after the ink attaching step, a step of heating transfer paper. This step is a step of heating after a sublimation-transfer ink jet ink composition has been discharged and attached to transfer paper. This step promotes drying of a sublimation-transfer ink jet ink composition attached in the ink attaching step and suppresses bleeding of images as well as ink setoff in some cases. Herein, the term “ink setoff” indicates a phenomenon in which components of a sublimation-transfer ink jet ink composition are transferred to the rear surface in contact with the recording surface when transfer paper is disposed on one another, for example, by taking-up on a roll.

In this step, the temperature that transfer paper reaches is preferably 60.0° C. or higher and more preferably 70.0° C. or higher and 120.0° C. or lower. Within this range, sublimation dyes are unlikely to sublime and a satisfactory drying speed is achieved.

According to the production method for a printed article of the present embodiment, an unprecedented printed article of green tone having satisfactory fluorescent whitening intensity is obtained since the above-described sublimation-transfer ink jet ink composition is used. In other words, according to the production method for a printed article of the present embodiment, it is possible to produce a printed article dyed with green tone having satisfactory fluorescent whitening intensity.

### 3. Examples and Comparative Examples

Hereinafter, the present disclosure will be described specifically by means of Examples. However, the present disclosure is by no means limited to these Examples. Hereinafter, “part(s)” and “%” are based on mass unless otherwise indicated. Evaluation was performed in an environment of a temperature of 25.0° C. and a relative humidity of 40.0% unless otherwise indicated.

### 3. 1. Preparation of Ink Compositions

The respective components were fed to a container to satisfy the composition shown in Table 1, mixed and stirred with a magnetic stirrer for 2 hours, and further mixed sufficiently through dispersion treatment in a bead mill filled with zirconia beads of 0.3 mm in diameter. After stirring for 1 hour, the resulting mixture was filtered using a 5.0 μm-PTFE membrane filter to yield each ink composition of Examples and Comparative Examples. The numerical values in Table 1 represent mass %. Deionized water was used as water and added such that the mass of each ink composition amounts to 100 mass %.

TABLE 1

| | | Ex. | | | | | | | | | | Comp. Ex. | | |
|---|---|---|---|---|---|---|---|---|---|---|---|---|---|---|
| Table 1: | | 1 | 2 | 3 | 4 | 5 | 6 | 7 | 8 | 9 | 10 | 1 | 2 | 3 |
| Dye | C.I. Solvent | 7.5 | 7.5 | 7.5 | 7.5 | 7.5 | 10.0 | 5.0 | 0.2 | 11.3 | 15.0 | 7.5 | 7.5 | — |
| | Yellow 160:1 | | | | | | | | | | | | | |
| | C.I. Disperse | — | — | — | — | — | — | — | — | — | — | — | — | 7.5 |
| | Yellow82 | | | | | | | | | | | | | |
| | C.I. Disperse | 7.5 | — | — | — | 2.5 | 5.0 | 10.0 | 0.2 | 11.3 | 15.0 | — | — | 7.5 |
| | Blue 60 | | | | | | | | | | | | | |
| | C.I. Disperse | — | 7.5 | — | — | 2.5 | — | — | — | — | — | — | — | — |
| | Blue 359 | | | | | | | | | | | | | |
| | C.I. Disperse | — | — | 7.5 | 7.5 | 2.5 | — | — | — | — | — | — | — | — |
| | Blue 360 | | | | | | | | | | | | | |
| | C.I. Disperse | — | — | — | — | — | — | — | — | — | — | — | — | — |
| | Blue 72 | | | | | | | | | | | | | |
| | C.I. Disperse | — | — | — | — | — | — | — | — | — | — | — | 7.5 | — |
| | Blue 183 | | | | | | | | | | | | | |
| Dispersant | Naphthalenesulfonic | 15.0 | 15.0 | 15.0 | — | 15.0 | 15.0 | 15.0 | 0.4 | 22.6 | 30.0 | 15.0 | — | 15.0 |
| | acid-formaldehyde | | | | | | | | | | | | | |
| | condensate sodium | | | | | | | | | | | | | |
| | salt | | | | | | | | | | | | | |
| | Acrylic-styrene | — | — | — | 15.0 | — | — | — | — | — | — | — | 15.0 | — |
| | copolymer | | | | | | | | | | | | | |
| Water- | Glycerol | 15.0 | 15.0 | 15.0 | 15.0 | 15.0 | 15.0 | 15.0 | 15.0 | 15.0 | 15.0 | 15.0 | 15.0 | 15.0 |
| soluble | Propylene glycol | 10.0 | 10.0 | 10.0 | 10.0 | 10.0 | 10.0 | 10.0 | 10.0 | 10.0 | 10.0 | 10.0 | 10.0 | 10.0 |
| organic | | | | | | | | | | | | | | |
| solvent | | | | | | | | | | | | | | |
| Surfactant | BYK348 | 0.5 | 0.5 | 0.5 | 0.5 | 0.5 | 0.5 | 0.5 | 0.5 | 0.5 | 0.5 | 0.5 | 0.5 | 0.5 |
| pH adjuster | Triethanolamine | 0.5 | 0.5 | 0.5 | 0.5 | 0.5 | 0.5 | 0.5 | 0.5 | 0.5 | 0.5 | 0.5 | 0.5 | 0.5 |
| Water | | bal- | bal- | bal- | bal- | bal- | bal- | bal- | bal- | bal- | bal- | bal- | bal- | bal- |
| | | ance | ance | ance | ance | ance | ance | ance | ance | ance | ance | ance | ance | ance |
| Evaluation | Fluorescent | A | A | A | A | A | A | A | A | A | B | B | B | C |
| results | whitening intensity | | | | | | | | | | | | | |
| | of textile | | | | | | | | | | | | | |
| | Dispersion | B | A | B | B | B | B | B | B | B | B | C | C | B |
| | stability | | | | | | | | | | | | | |

Among the components shown in Table 1, the surfactant is a polyether-modified siloxane surfactant of trade name “BYK®-349” from BYK Japan KK. As a dispersant, naphthalenesulfonic acid-formaldehyde condensate sodium salt is “Demol NL” from Kao Corporation. As the other dispersant, the acrylic-styrene copolymer is “Joncryl 678” from BASF SE.

### 3. 2. Preparation of Printed Articles

An ink cartridge was filled with a sublimation-transfer ink jet ink composition of each example and set in an ink jet printer (PX-H6000 from Seiko Epson Corporation). Subsequently, a recording head of the printer was filled with the sublimation-transfer ink jet ink composition by using a printer driver, and it was confirmed that normal recording was possible without clogged nozzles.

By using this ink jet printer, a sublimation-transfer ink jet ink composition of each example was discharged to print a solid pattern and a pattern of 10% ink amount at a recording resolution of 1440×720 dpi on Transjet Classic (from Cham Paper Group Holding AG) as an intermediate transfer medium. Here, the operating environment of the printer was set to 40.0° C. and 20.0% RH.

Subsequently, the surface of the intermediate transfer medium to which a sublimation-transfer ink jet ink composition had been attached was brought into contact with a textile (100% polyester, Amina from Toray Industries, Inc.) as a white recording medium and subjected to sublimation transfer in this state by heating using a heat press (TP-608M from Taiyoseiki) under conditions of 200.0° C. and 60.0 seconds to yield a printed article of each example.

### 3. 3. Evaluation Tests

The obtained transferred articles underwent the following evaluation tests.

### 3. 3. 1. Evaluation of Fluorescent Whitening Intensity

Fluorescent whitening intensity was measured using a spectrodensitometer FD-7 (from Konica Minolta, Inc.) for textiles after transfer (pattern portion of 10% ink amount). The measurement conditions are as follows.

Color measurement: reflectance measurement

Measurement condition: M1 [D50]

Display mode: absolute

Observer: 2°

Illuminant: D50

Polarization filter: not attached

Fluorescent whitening intensity was measured three times for each example to obtain an average and evaluated in accordance with the following criteria. The results are shown in Table 1.

A: fluorescent whitening intensity of 3 or more

B: fluorescent whitening intensity of 2 or more and less than 3

C: fluorescent whitening intensity of 1 or more and less than 2

### 3. 3. 2. Evaluation of Dispersion Stability

An ink storage container filled with a sublimation-transfer ink jet ink composition of each example was left in an environment of 60.0° C. for 1 week. An average particle size of dispersed dyes was measured for each sublimation-transfer ink jet ink composition before and after such storage. The average particle size was obtained by measuring a volume-based particle size at 50% using Microtrac UPA (from Nikkiso Co., Ltd.) and evaluated in accordance with the following criteria. The results are shown in Table 1.

A: change in average particle size of less than 10%

B: change in average particle size of 10% or more and less than 15%

C: change in average particle size of 15% or more

### 3. 4. Evaluation Results

It was revealed that a sublimation-transfer ink jet ink composition of each Example that contains C.I. Solvent Yellow 160:1 as a yellow dye and one or more selected from C.I. Disperse Blue 60, C.I. Disperse Blue 359, and C.I. Disperse Blue 360 as blue dyes exhibits satisfactory fluorescent whitening intensity and satisfactory dispersion stability.

The present disclosure is not limited to the above-described embodiments, and various modifications are possible. For example, the present disclosure encompasses the constitution substantially the same as the constitution described in the embodiments (constitution with the same function, method, and results; or constitution with the same object and effects, for example). In addition, the present disclosure encompasses the constitution in which a nonessential portion of the constitution described in the embodiments is replaced. Moreover, the present disclosure encompasses the constitution that exerts the same action and effects as the constitution described in the embodiments or the constitution that can attain the same object as the constitution described in the embodiments. Further, the present disclosure encompasses the constitution in which a publicly known technique is added to the constitution described in the embodiments.

What is claimed is:

1. A sublimation-transfer ink jet ink composition comprising dyes and water, wherein
the dyes include one or more yellow dyes and one or more blue dyes;
the yellow dyes include C.I. Solvent Yellow 160:1; and
the blue dyes include one or more selected from C.I. Disperse Blue 60, C.I. Disperse Blue 359, and C.I. Disperse Blue 360.

2. The sublimation-transfer ink jet ink composition according to claim 1, wherein
the dyes solely include the yellow dyes and the blue dyes.

3. The sublimation-transfer ink jet ink composition according to claim 1, further comprising an anionic dispersant.

4. The sublimation-transfer ink jet ink composition according to claim 3, wherein
the anionic dispersant is naphthalenesulfonic acid-formaldehyde condensate sodium salt.

5. The sublimation-transfer ink jet ink composition according to claim 1, wherein
a content of C.I. Solvent Yellow 160:1 is 0.5% by mass or more and 14.0% by mass or less based on a total amount of the sublimation-transfer ink jet ink composition.

6. The sublimation-transfer ink jet ink composition according to claim 1, wherein
a ratio of a content of C.I. Solvent Yellow 160:1 to a total content of the blue dyes is 0.5 or more and 2.0 or less.

7. A production method for a printed article comprising:
attaching the sublimation-transfer ink jet ink composition according to claim 1 to a recording surface of transfer paper by an ink jet method; and
thermally transferring by disposing the recording surface and a recording medium to face each other, followed by heating.
